(19) United States
(12) Patent Application Publication
(10) Pub. No.: US 2024/0005212 A1
(43) Pub. Date: Jan. 4, 2024

(54) CORRECTION APPARATUS, PREDICTION APPARATUS, METHOD, NON-TRANSITORY COMPUTER-READABLE RECORDING MEDIUM STORING PROGRAM, AND CORRECTION MODEL

(71) Applicant: DAIKIN INDUSTRIES, LTD., Osaka (JP)

(72) Inventors: Manabu YOSHIMI, Osaka (JP); Shinichi KASAHARA, Osaka (JP); Hiroki KITADE, Osaka (JP)

(21) Appl. No.: 18/467,090

(22) Filed: Sep. 14, 2023

Related U.S. Application Data
(63) Continuation of application No. PCT/JP2022/012808, filed on Mar. 18, 2022.

(30) Foreign Application Priority Data
Mar. 18, 2021 (JP) 2021-044569

(51) Int. Cl. G06N 20/00

(52) U.S. Cl. CPC G06N 20/00

(57) ABSTRACT

An object is to predict an operational state from operational data when there is no operational data to learn from. An apparatus according to an embodiment of the present disclosure is an apparatus configured to perform correction regarding a predicted value for an operational state predicted from operational data of a device, and includes a provisional prediction model that is trained by machine learning based on training data including operational data and an operational state of a device different from the device, and a correction unit configured to perform correction regarding the predicted value for the operational state of the device, the predicted value being predicted using the provisional prediction model.

### CROSS-REFERENCE TO RELATED APPLICATIONS

This application is a continuation application of International Application No. PCT/JP2022/012808, filed on Mar. 18, 2022, and designating the U.S., which is based upon and claims priority to Japanese Patent Application No. 2021-044569, filed on Mar. 18, 2021, the entire contents of which are incorporated herein by reference.

### BACKGROUND

### Technical Field

The present disclosure relates to a correction apparatus, a prediction apparatus, a method, a program, and a correction model.

### Background Art

A hitherto known system is configured to predict an operational state of a device such as an air conditioner from operational data of the device using a prediction model generated by machine learning, and control operations of the device or diagnose failures of the device (Japanese Patent Application Publication No. 2020-109581).

### SUMMARY

An apparatus according to an aspect of the present disclosure is an apparatus configured to perform correction regarding a predicted value for an operational state predicted from operational data of a device, and includes:
a provisional prediction model that is trained by machine learning based on training data including operational data and an operational state of a device different from the device; and
a correction unit configured to perform correction regarding the predicted value for the operational state of the device, the predicted value being predicted using the provisional prediction model.

### BRIEF DESCRIPTION OF THE DRAWINGS

FIG. 1 is a diagram illustrating an overview of the present disclosure;

FIG. 2 is an example of an overall configuration of the present disclosure;

FIG. 3 is a diagram of a hardware configuration of an air conditioning system (in a case of an air-cooling operation) according to an embodiment of the present disclosure;

FIG. 4 is a diagram of a hardware configuration of an air conditioning system (in a case of an air-warming operation) according to an embodiment of the present disclosure;

FIG. 5 is a diagram of a hardware configuration of an air conditioning system (in a case of a simultaneous air-cooling and warming operation) according to an embodiment of the present disclosure;

FIG. 6 is a diagram of a hardware configuration of a correction model generation apparatus, a prediction apparatus, and a provisional prediction model generation apparatus according to an embodiment of the present disclosure;

FIG. 7 is a functional block diagram of a correction model generation apparatus according to an embodiment of the present disclosure;

FIG. 8 is a functional block diagram of a prediction apparatus according to an embodiment of the present disclosure;

FIG. 9 is a flowchart for a provisional prediction model generation process according to an embodiment of the present disclosure;

FIG. 10 is a flowchart for a correction model generation process according to an embodiment of the present disclosure;

FIG. 11 is a flowchart for a prediction process according to an embodiment of the present disclosure;

FIG. 12 is a diagram illustrating updating of a provisional prediction model and a correction model to a prediction model according to an embodiment of the present disclosure;

FIG. 13 is a diagram illustrating updating of a correction model according to an embodiment of the present disclosure;

FIG. 14 is a diagram illustrating another embodiment for generation of a correction model according to an embodiment of the present disclosure;

FIG. 15 is a diagram illustrating correction of an abnormality determination threshold according to an embodiment of the present disclosure; and

FIG. 16 is a diagram illustrating correction of a control gain involved in device control according to an embodiment of the present disclosure.

### DESCRIPTION OF EMBODIMENTS

Embodiments of the present disclosure will be described below with reference to the drawings.

An apparatus configured to perform correction regarding a predicted value for an operational state predicted from operational data of a device (hereinafter, the apparatus may also be referred to as a correction apparatus) will be described below. The correction apparatus includes a provisional prediction model that is trained by machine learning based on training data including operational data and an operational state of a device different from the device, and a correction unit configured to perform correction regarding a predicted value for the operational state of the device predicted using the provisional prediction model.

Specifically, the correction apparatus can generate a correction model configured to correct a predicted value for the operational state of the device predicted using the provisional prediction model (embodiment 1). The correction apparatus can also correct an abnormality determination threshold using the predicted value for the operational state of the device predicted using the provisional prediction model (embodiment 2). The correction apparatus can correct a control gain involved in a control using the predicted value for the operational state of the device predicted using the provisional prediction model (embodiment 3).

### Embodiment 1

### Overview

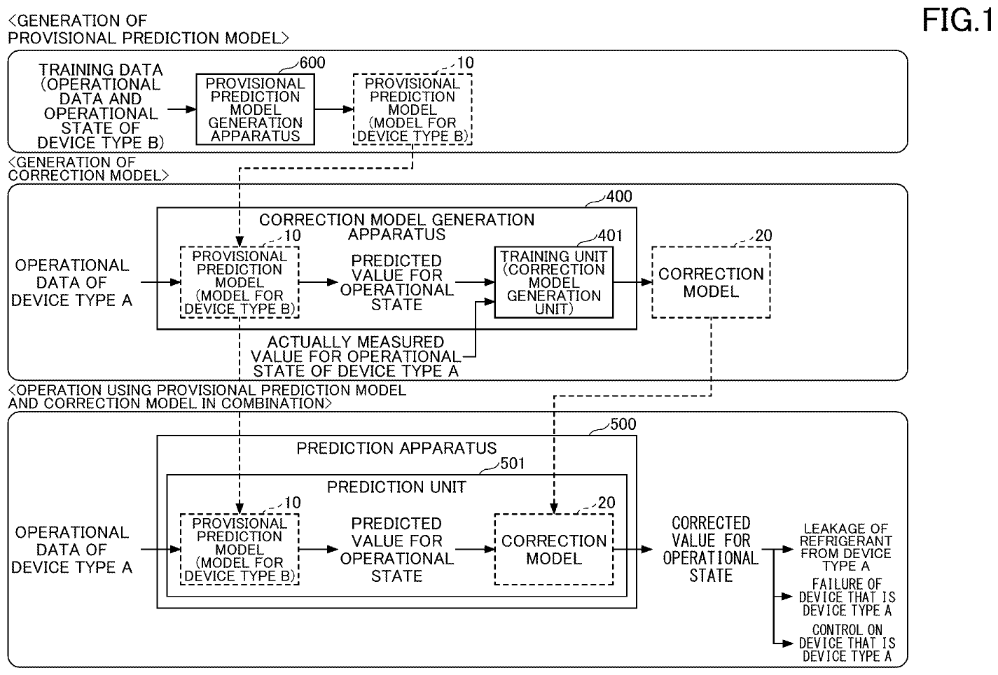

FIG. 1 is a diagram illustrating an overview of the present disclosure. <Generation of provisional prediction model>, <Generation of correction model>, and <Operation using provisional prediction model and correction model in combination> will be described below in this order. For example, the device is an air conditioner. For example, a device type A is a new device type, and a device type B is an old device type.

<Generation of Provisional Prediction Model>

First, a provisional prediction model generation apparatus 600 generates a provisional prediction model 10. Specifically, the provisional prediction model generation apparatus 600 generates a provisional prediction model (i.e., a model for the device type B) 10 by performing machine learning using training data (specifically, by performing machine learning by associating operational data and an operational state of a device that is device type B with each other).

<Generation of Correction Model>

Next, a correction model generation apparatus (an example of the correction apparatus) 400 generates a correction model 20. The correction model 20 is a model configured to correct a predicted value for an operational state.

Specifically, the correction model generation apparatus 400 acquires a predicted value for an operational state of a device that is device type A, by inputting operational data of the device that is device type A into the provisional prediction model (i.e., the model for the device type B) 10 to output an operational state. The correction model generation apparatus 400 acquires an actually measured value for the operational state of the device that is device type A (specifically, the actually measured value is an operational state calculated from the operational data of the device that is device type A). Then, the correction model generation apparatus 400 generates the correction model 20 by performing machine learning by associating the predicted value for the operational state of the device that is device type A with the actually measured value for the operational state of the device that is device type A (note that the machine learning may be performing by associating the predicted value for the operational state of the device that is device type A and the operational data of the device that is device type A with the actually measured value for the operational state of the device that is device type A). In this case, the operational data of the device type A necessary for generating the correction model is typically not operational data accumulated over a long period of time necessary for generating a prediction model for the device type A, and need only be operational data accumulated over a short period of time. For example, operational data acquired in a test room during development of the device type A, and data of a test operation during installation may be used.

<Operation Using Provisional Prediction Model and Correction Model in Combination>

Subsequently, the device that is device type A starts to be operated. A prediction apparatus 500 predicts an operational state from operational data of the device that is device type A.

Specifically, the prediction apparatus 500 acquires a predicted value for an operational state of the device that is device type A by inputting operational data of the device that is device type A into the provisional prediction model (i.e., the model for the device type B) 10 to output an operational state. Moreover, the prediction apparatus 500 acquires a corrected predicted value for the operational state of the device that is device type A by inputting the predicted value for the operational state of the device that is device type A into the correction model 20 to output the corrected predicted value for the operational state (the corrected predicted value for the operational state of the device that is device type A may be acquired by inputting the predicted value for the operational state of the device that is device type A and the operational data of the device that is device type A into the correction model 20).

In this way, by generating a correction model using a small amount of operational data of the device that is device type A (e.g., a new device type), and using this correction model and the provisional prediction model for the device type B (e.g., an old device type), it is possible to predict an operational state from the operational data of the device that is device type A without generating a prediction model dedicated to the device type A.

<Example of Overall Configuration>

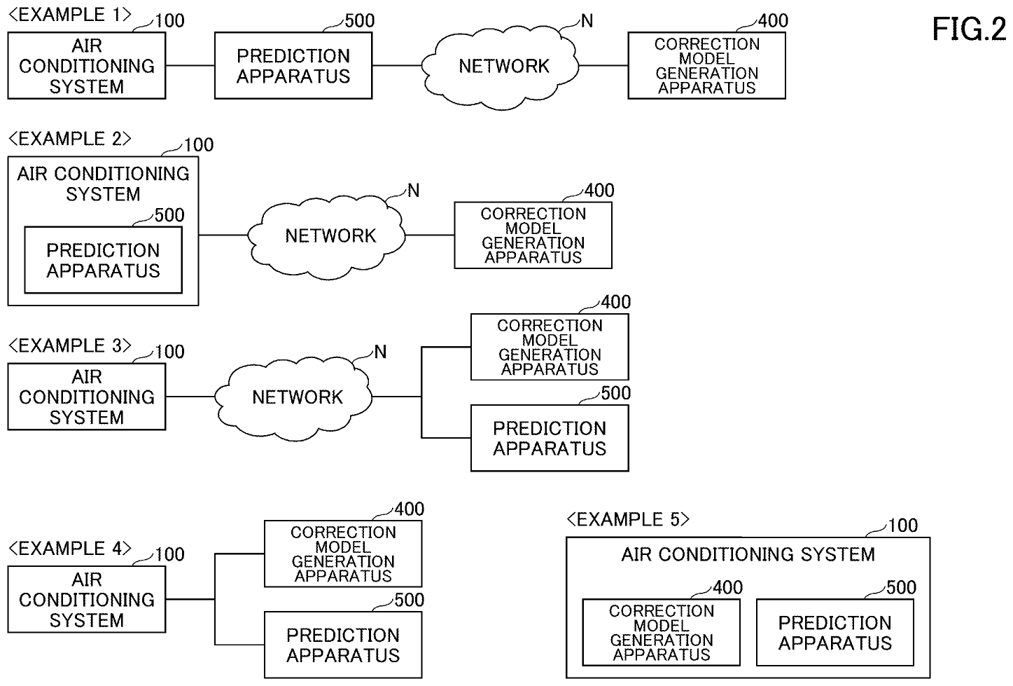

FIG. 2 is an example of the overall configuration of the present disclosure.

As illustrated in <Example 1>, the prediction apparatus 500 may be implemented on a computer installed in, for example, the same building as that in which an air conditioning system 100 is installed. The correction model generation apparatus 400 may be implemented on a cloud server apart from the air conditioning system 100 and the prediction apparatus 500.

As illustrated in <Example 2>, the prediction apparatus 500 may be implemented as a part of the air conditioning system 100 (e.g., may be installed in an outdoor unit 200 or an indoor unit 300). The correction model generation apparatus 400 may be implemented on a cloud server apart from the air conditioning system 100 and the prediction apparatus 500.

As illustrated in <Example 3>, the correction model generation apparatus 400 and the prediction apparatus 500 may be implemented on a cloud server apart from the air conditioning system 100. The correction model generation apparatus 400 and the prediction apparatus 500 may be implemented on one apparatus.

As illustrated in <Example 4>, the correction model generation apparatus 400 and the prediction apparatus 500 may be implemented on a computer installed in, for example, the same building as that in which the air conditioning system 100 is installed. The correction model generation apparatus 400 and the prediction apparatus 500 may be implemented on one apparatus.

As illustrated in <Example 5>, the correction model generation apparatus 400 and the prediction apparatus 500 may be implemented as a part of the air conditioning system 100 (e.g., may be installed in an outdoor unit 200 or an indoor unit 300). The correction model generation apparatus 400 and the prediction apparatus 500 may be implemented on one apparatus.

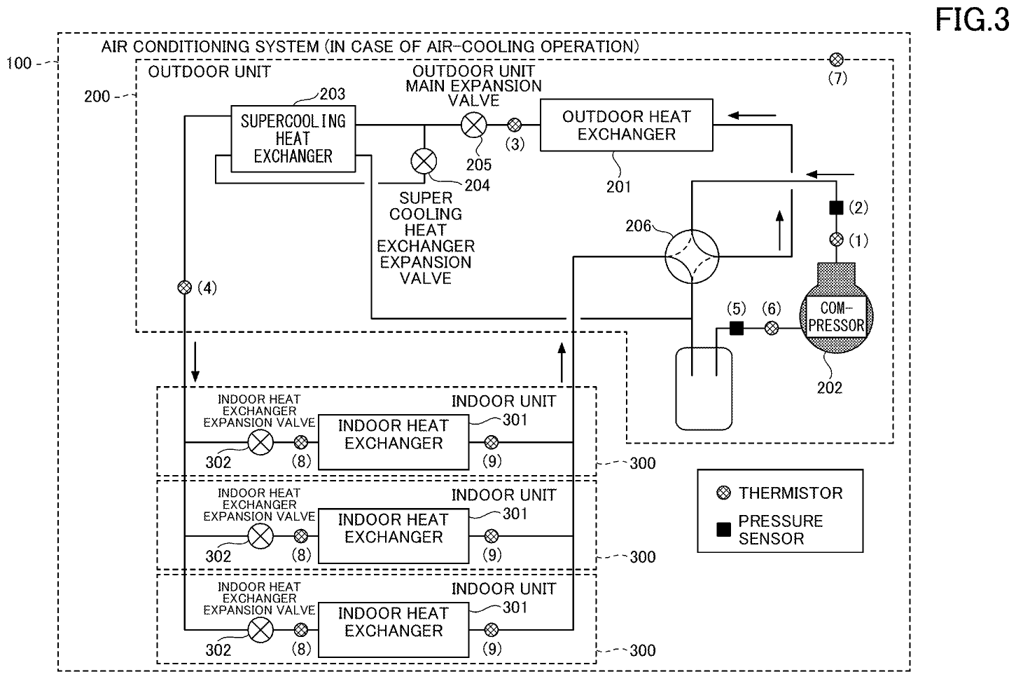

The hardware configuration of the air conditioning system 100 will be described with reference to FIG. 3 to FIG. 5. The air conditioning system 100 may be any desirably selected air conditioning system such as a multi-type air conditioner such as a multi-type air conditioner for buildings, a central air-conditioning system using a chiller as a heat source, an air conditioner for shops and offices, and a room air conditioner, or may be intended for purposes other than air-cooling and warming, and may be a refrigeration/freezing system. The air conditioning system 100 may include a plurality of indoor units 300. The plurality of indoor units 300 may include indoor units having different performances, may include indoor units having the same performance, or may include indoor units in a stopped state.

<Hardware Configuration of Air Conditioning System (in a Case of Air-Cooling Operation)>

FIG. 3 is a diagram of the hardware configuration of the air conditioning system (in a case of an air-cooling operation) 100 according to an embodiment of the present disclosure. The air conditioning system 100 includes an outdoor unit 200 and one or a plurality of indoor units 300.

In the example of FIG. 3, an outdoor heat exchanger 201, an outdoor unit main expansion valve 205, a supercooling heat exchanger 203, an indoor heat exchanger expansion valve 302, a four-way valve 206, an indoor heat exchanger 301, and a compressor 202 are coupled through a refrigerant pipe, and constitute a main refrigerant circuit. Flow paths in the four-way valve 206 are set such that a gas discharged from the compressor 202 is supplied to the outdoor heat exchanger 201. In the example of FIG. 3, a supercooling heat exchanger expansion valve 204 is further provided on a bypass pipe that is connected from a pipe between the outdoor heat exchanger 201 and the supercooling heat exchanger 203 to a pipe at a suction side of the compressor 202. The supercooling heat exchanger 203 is a heat exchanger configured to make a refrigerant, which has passed through the supercooling heat exchanger expansion valve 204 provided on the bypass pipe connected from between the outdoor heat exchanger 201 and the supercooling heat exchanger 203 to the pipe at the suction side of the compressor 202, exchange heat with a refrigerant in the main refrigerant circuit. The bypassing example of FIG. 3 is an example.

<<Outdoor Unit>>

In the outdoor unit 200, the outdoor heat exchanger 201, the compressor 202, the supercooling heat exchanger 203, the supercooling heat exchanger expansion valve (bypass circuit) 204, and the outdoor unit main expansion valve (main refrigerant circuit) 205 are connected to piping. The outdoor unit 200 includes various sensors (e.g., temperature sensors (e.g., thermistors) (1), (3), (4), (6), and (7), and pressure sensors (2) and (5)).

<<Indoor Unit>>

In the indoor unit 300, the indoor heat exchanger 301 and the indoor heat exchanger expansion valve 302 are connected to piping. The indoor unit 300 includes various sensors (e.g., temperature sensors (e.g., thermistors) (8) and (9)).

<Hardware Configuration of Air Conditioning System (in a Case of Air-Warming Operation)>

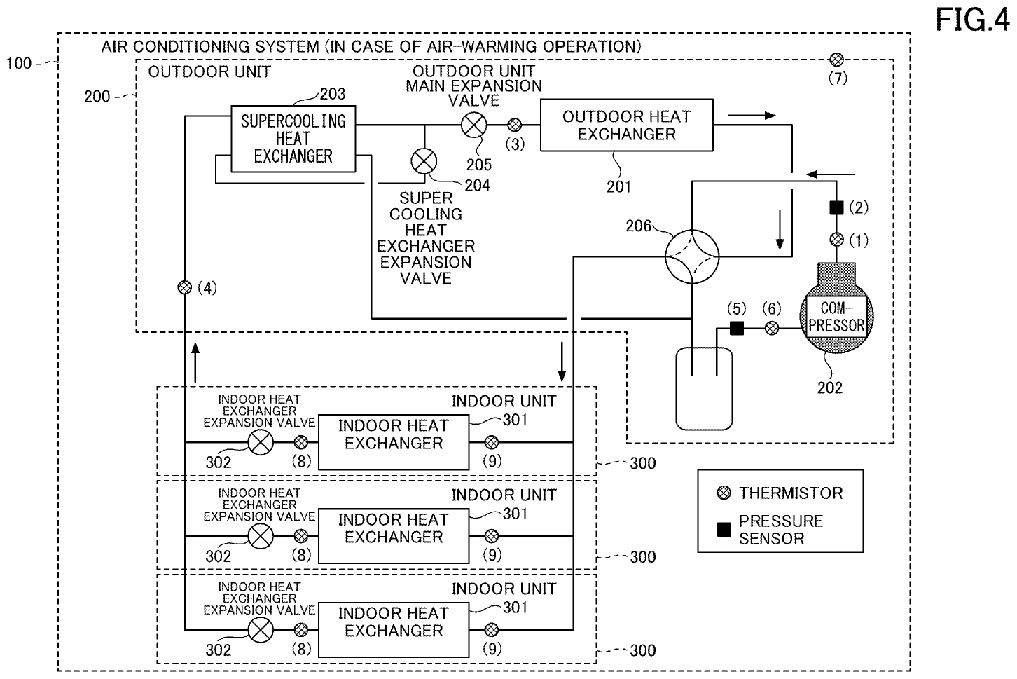

FIG. 4 is a diagram of the hardware configuration of the air conditioning system (in a case of an air-warming operation) 100 according to an embodiment of the present disclosure. The air conditioning system 100 includes an outdoor unit 200 and one or a plurality of indoor units 300.

In the example FIG. 4, an outdoor heat exchanger 201, a compressor 202, a four-way valve 206, an indoor heat exchanger 301, an indoor heat exchanger expansion valve 302, a supercooling heat exchanger 203, and an outdoor unit main expansion valve 205 are coupled through refrigerant piping, and together constitute a main refrigerant circuit. Flow paths in the four-way valve 206 are set such that a gas discharged from the compressor 202 is supplied to the indoor heat exchanger 301.

<<Outdoor Unit>>

In the outdoor unit 200, the outdoor heat exchanger 201, the compressor 202, the supercooling heat exchanger 203, a supercooling heat exchanger expansion valve (bypass circuit) 204, and the outdoor unit main expansion valve (main refrigerant circuit) 205 are connected to the piping. The outdoor unit 200 includes various sensors (e.g., temperature sensors (e.g., thermistors) (1), (3), (4), (6), and (7), and pressure sensors (2) and (5)).

<<Indoor Unit>>

In the indoor unit 300, the indoor heat exchanger 301 and the indoor heat exchanger expansion valve 302 are connected to a pipe. The indoor unit 300 includes various sensors (e.g., temperature sensors (e.g., thermistors) (8) and (9)).

<Hardware Configuration of Air Conditioning System (in a Case of Simultaneous Air-Cooling and Warming Operation)>

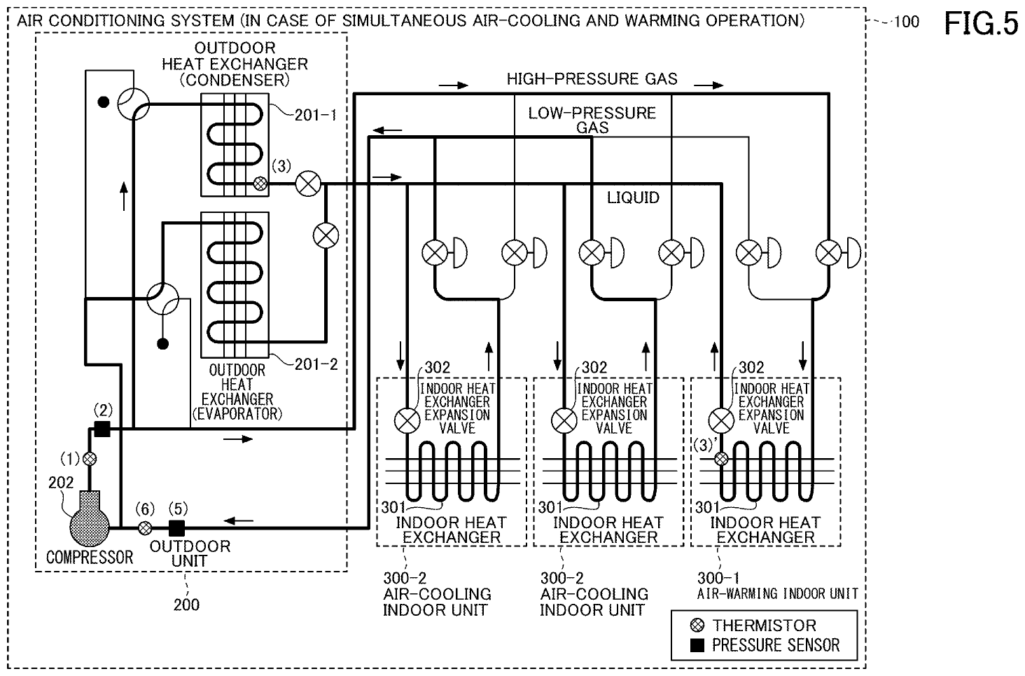

The present disclosure is not limited to an ai-cooling operation and an air-warming operation, and can be applied to a simultaneous air-cooling and warming operation. A simultaneous air-cooling and warming operation will be described below with reference to FIG. 5.

FIG. 5 is a diagram of the hardware configuration of the air conditioning system (in a case of a simultaneous air-cooling and warming operation) 100 according to an embodiment of the present disclosure. An air conditioning system 100, in which an outdoor heat exchanger 201-1 and an outdoor heat exchanger 201-2, which have a two-parted structure, and a plurality of indoor units are coupled through three communicating pipes, can perform a simultaneous air-cooling and warming operation. FIG. 5 illustrates an operation example in which air cooling is main, and an indoor unit 300-1 is operated in an air-warming mode whereas an indoor unit 300-2 is operated in an air-cooling mode. Here, the outdoor heat exchanger 201-1 functions as a condenser whereas the outdoor heat exchanger 201-2 functions as an evaporator.

<Hardware Configurations of Correction Model Generation Apparatus, Prediction Apparatus, and Provisional Prediction Model Generation Apparatus>

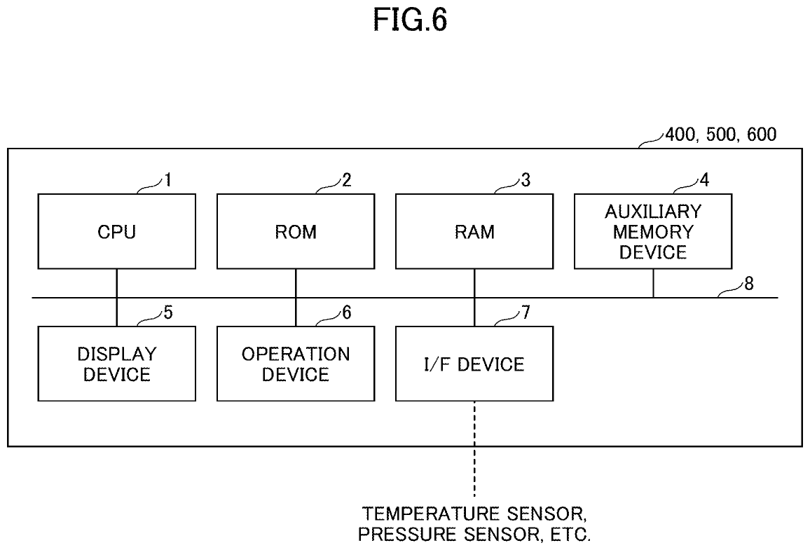

FIG. 6 is a diagram of the hardware configurations of the correction model generation apparatus 400, the prediction apparatus 500, and the provisional prediction model generation apparatus 600 according to an embodiment of the present disclosure.

The correction model generation apparatus 400, the prediction apparatus 500, and the provisional prediction model generation apparatus 600 each include a Central Processing Unit (CPU) 1, a Read Only Memory (ROM) 2, and a Random Access Memory (RAM) 3. The CPU 1, the ROM 2, and the RAM 3 form what is generally referred to as a computer.

The correction model generation apparatus 400, the prediction apparatus 500, and the provisional prediction model generation apparatus 600 can each be equipped with an auxiliary memory device 4, a display device 5, an operation device 6, and an Interface (I/F) device 7. The hardware components of the correction model generation apparatus 400, the prediction apparatus 500, and the provisional prediction model generation apparatus 600 are mutually coupled through a bus 8.

The CPU 1 is an operation device configured to execute various programs installed on the auxiliary memory device 4.

The ROM 2 is a nonvolatile memory. The ROM 2 functions as a main memory device configured to store, for example, various programs and data needed for the CPU 1 to execute the various programs installed on the auxiliary memory device 4. Specifically, the ROM 2 functions as a main memory device configured to store, for example, a boot program such as a Basic Input/Output System (BIOS) or an Extensible Firmware Interface (EFI).

The RAM 3 is a volatile memory such as a Dynamic Random Access Memory (DRAM) or a Static Random Access Memory (SRAM). The RAM 3 functions as a main memory device configured to provide a work area in which various programs installed on the auxiliary memory device 4 are deployed when executed by the CPU 1.

The auxiliary memory device 4 is an auxiliary memory device configured to store various programs and information used when the various programs are executed.

The display device 5 is a display device configured to display, for example, internal statuses of the correction model generation apparatus 400, the prediction apparatus 500, and the provisional prediction model generation apparatus 600.

The operation device 6 is an input device via which administrators of the correction model generation apparatus 400, the prediction apparatus 500, and the provisional prediction model generation apparatus 600 input various instructions into the correction model generation apparatus 400, the prediction apparatus 500, and the provisional prediction model generation apparatus 600.

The I/F device 7 is a communication device configured to connect to various sensors and networks to communicate with other terminals.

<Functional Blocks>

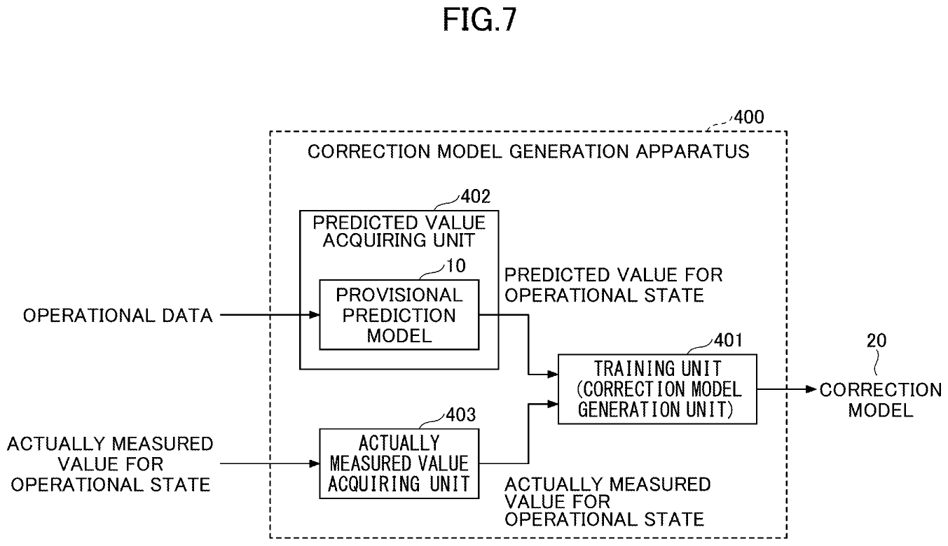

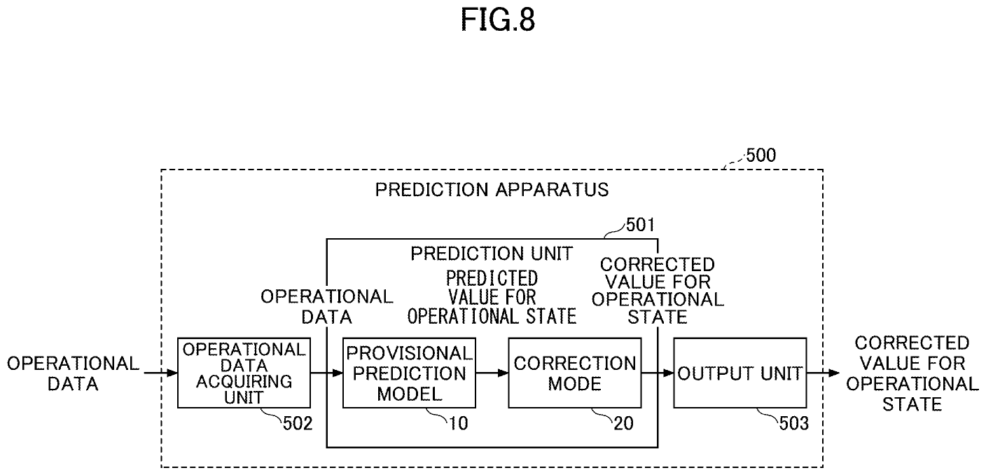

The functional blocks of the correction model generation apparatus 400 will be described with reference to FIG. 7, and the functional blocks of the prediction apparatus 500 will be described with reference to FIG. 8.

FIG. 7 is a functional block diagram of the correction model generation apparatus 400 according to an embodiment of the present disclosure. As illustrated in FIG. 7, the correction model generation apparatus 400 includes a training unit (correction model generation unit) 401, a predicted value acquiring unit 402, and an actually measured value acquiring unit 403. The correction model generation apparatus 400 functions as the training unit (correction model generation unit) 401, the predicted value acquiring unit 402, and the actually measured value acquiring unit 403 by executing programs. Each unit will be described below.

The predicted value acquiring unit 402 is configured to acquire operational data of the device that is device type A. The predicted value acquiring unit 402 is also configured to input the operational data of the device that is device type A into the provisional prediction model (i.e., the model for the device type B) 10 to output a predicted value for an operational state.

The actually measured value acquiring unit 403 is configured to acquire an actually measured value for an operational state of the device that is device type A (i.e., an operational state calculated from the operational data of the device that is device type A). The actually measured value acquiring unit 403 can calculate an operational state from the operational data of the device that is device type A.

The training unit (correction model generation unit (which is an example of a correction unit)) 401 is configured to generate the correction model 20. Specifically, the training unit (correction model generation unit) 401 is configured to generate the correction model 20 by performing machine learning by associating the predicted value for the operational state of the device that is device type A acquired by the predicted value acquiring unit 402 with the actually measured value for the operational state of the device that is device type A acquired by the actually measured value acquiring unit 403.

FIG. 8 is a functional block diagram of the prediction apparatus 500 according to an embodiment of the present disclosure. As illustrated in FIG. 8, the prediction apparatus 500 includes a prediction unit 501, an operational data acquiring unit 502, and an output unit 503. The prediction apparatus 500 functions as the prediction unit 501, the operational data acquiring unit 502, and the output unit 503 by executing programs. Each unit will be described below.

The operational data acquiring unit 502 is configured to acquire operational data (specifically, operational data of the device that is device type A).

The prediction unit 501 is configured to acquire a predicted value for an operational state of the device that is device type A by inputting the operational data of the device that is device type A acquired by the operational data acquiring unit 502 into the provisional prediction model (i.e., the model for the device type B) 10 to output an operational state. The prediction unit 501 is also configured to acquire a corrected predicted value for the operational state of the device that is device type A by inputting the predicted value for the operational state of the device that is device type A into the correction model to output the corrected predicted value for the operational state.

The output unit 503 is configured to output the corrected predicted value for the operational state of the device that is device type A predicted by the prediction unit 501. Subsequently, the corrected predicted value for the operational state of the device that is device type A may be used in order to sense leakage of a refrigerant from the device that is device type A, sense a failure of the device that is device type A, or control the device that is device type A.

### Examples of Operational Data

Here, examples of the operational data of the device will be described.

### Example 1

For example, the operational data of the device may include at least one selected from the following.
Condensation temperature
Evaporation temperature
Condenser outlet temperature
Evaporator outlet temperature
Outdoor temperature
Rotation rate of the compressor 202
Opening degree of the supercooling heat exchanger expansion valve 204
Electrical current value of the compressor 202

### Example 2

For example, the operational data of the device may include at least one selected from the following in addition to the operational data described above (Example 1) or instead of the operational data described above (Example 1).
Opening degree of the indoor heat exchanger expansion valve 302
Opening degree of the outdoor unit main expansion valve 205
Total value of rated capacities of the indoor units under operation or on standby for operation
Number of operating indoor units
Capabilities of the indoor units (air-cooling or air-warming)
Blowoff temperature of the indoor units
Indoor temperature
Refrigerant temperature in a pipe connected to a liquid closing valve of the outdoor unit (a liquid temperature in a communicating pipe sensed by the thermistor (4) in FIG. 3 and FIG. 4)
Refrigerant temperature in a liquid communicating pipe (a temperature measured in a communicating pipe outside the outdoor unit 200 sensed by an externally attached sensor attached outside the outdoor unit 200)
Air flow rate of an outdoor unit's fan
Air flow rates of indoor units' fans
Rotation rate (step, tap) of an outdoor
Rotation rates (step, tap) of indoor units' fans
Electrical current value of an outdoor unit's fan
Electrical current values of indoor units' fans
Amount of a refrigerant circulated
Discharging temperature of the compressor 202
Suction temperature of the compressor 202
Superheating degree in discharge of the compressor 202
Superheating degree in suction of the compressor 202
Supercooling degree at the supercooling heat exchanger 203 outlet (in a case of including a supercooling heat exchanger circuit)
Superheating degree at the supercooling heat exchanger 203 outlet (gas pipe side) (in a case of including a supercooling heat exchanger circuit)
Supercooling degree at the outlet of an economizer (in a case of including an economizer circuit)
Opening degree of an expansion valve for an economizer (in a case of including an economizer circuit)
Pressure at the outlet at an economizer bypass side (in a case of including an economizer circuit)
Opening degree of an expansion valve for intermediate injection (in a case of including an intermediate injection circuit)
Intermediate injection temperature (in a case of including an intermediate injection circuit)
Intermediate injection pressure (in a case of including an intermediate injection circuit)
Water temperature at the inlet of the evaporator (in a case where either or both of a heat source side and a use side is/are a water cooling type)
Water temperature at the outlet of the evaporator (in a case where either or both of a heat source side and a use side is/are a water cooling type)
Water temperature at the inlet of the condenser (in a case where either or both of a heat source side and a use side is/are a water cooling type)
Water temperature at the outlet of the condenser (in a case where either or both of a heat source side and a use side is/are a water cooling type)

### Example 3

For example, operational data for deducing a predicted value for an index value for a refrigerant amount during a normal operation may include either or both of the following in addition to the operational data described above (Example 1 and Example 2) or instead of the operational data described above (Example 1 and Example 2).
Number of defrosting times
Defrosting period of time

### Examples of Operational State

Here, examples of the operational state of the device will be described.

### (Example 1 (in a Case of Air-Cooling Operation))

For example, the operational state may include at least one selected from the following.
Condensation temperature—temperature at the outlet of the outdoor heat exchanger 201 (hereinafter, this is also referred to as a supercooling degree at the outlet of the outdoor heat exchanger. Superheating degree is also referred to as SC or subcool.)
Superheating degree in suction of the compressor (superheating degree is also referred to as SH or superheat).
Superheating degree in discharge of the compressor
Value based on the supercooling degree at the outlet of the outdoor heat exchanger or the suction superheating degree of the compressor or the discharge superheating degree of the compressor

For example, the value based on the supercooling degree at the outlet of the outdoor heat exchanger is a value calculated using the supercooling degree at the outlet of the outdoor heat exchanger. For example, a value calculated using the supercooling degree at the outlet of the outdoor heat exchanger is as descried below.
Value calculated using the supercooling degree at the outlet of the outdoor heat exchanger=supercooling degree at the outlet of the outdoor heat exchanger/(condensation temperature-outdoor temperature)

For example, the value based on the supercooling degree at the outlet of the outdoor heat exchanger is a value defined from physical properties of a refrigerant and refrigeration cycle diagrams (T-S and P-h diagrams).

### (Example 2 (in a Case of Air-Cooling Operation))

For example, the operational state may include at least one selected from the following in addition to the index value for the refrigerant amount described above (Example 1) or instead of the supercooling degree at the outlet of the outdoor heat exchanger in the index value for the refrigerant amount described above (Example 1).
Supercooling degree at the outlet of the supercooling heat exchanger
Value based on the supercooling degree at the outlet of the supercooling heat exchanger

### (Example 3 (in a Case of Air-Warming Operation))

In a case of an air-warming operation, the operational state may include at least one selected from the following instead of the operational states described above (Example 1 and Example 2).
Supercooling degree at the outlet of an indoor heat exchanger
Value based on the supercooling degree at the outlet of an indoor heat exchanger

The supercooling degree at the outlet of an indoor heat exchanger is any one selected from: at least one of the supercooling degrees of the plurality of indoor heat exchangers 301; the average of the supercooling degrees of the plurality of indoor heat exchangers 301; and the supercooling degree at the indoor junction or the outdoor junction of the plurality of indoor heat exchangers 301.

### (Example 4 (in a Case of Simultaneous Air-Cooling and Warming Operation))

In a case of a simultaneous air-cooling and warming operation, the operational state include the following in addition to the operational states described above (either or both of Example 1 and Example 2).
Combination of the supercooling degree at the outlet of an indoor heat exchanger (an indoor heat exchanger 301 of an air-warming indoor unit 300-1 of FIG. 5) and the supercooling degree at the outlet of the outdoor heat exchanger (the outdoor heat exchanger (condenser) 201-1 of FIG. 5)

### Examples of Device

Examples of the device will be described below.

For example, the device used for generating the correction model 20 is the device that is the same as and of the same device type as that of the device for which the prediction apparatus 500 performs prediction.

For example, the device used for generating the correction model 20 is one or a plurality of devices different from and of the same device type as that of the device for which the prediction apparatus 500 performs prediction.

For example, the device used for generating the correction model 20 include the device that is the same as and of the same device type as that of, and one or a plurality of devices different from and of the same device type as that of, the device for which the prediction apparatus 500 performs prediction.

For example, the device type of the device is a new device type of a device, which is of a device type different from that of the device. That is, the device type A is a new device type of the device type B.

For example, the device has a function similar to that of a device, which is of a device type different from that of the device. That is, the device type A and the device type B have a similar function.

<Method>

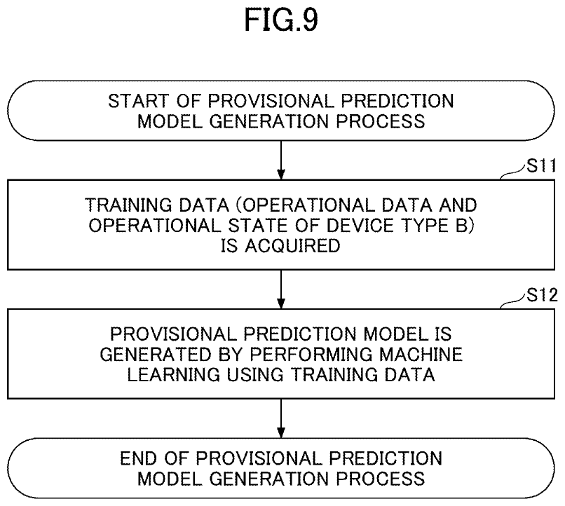

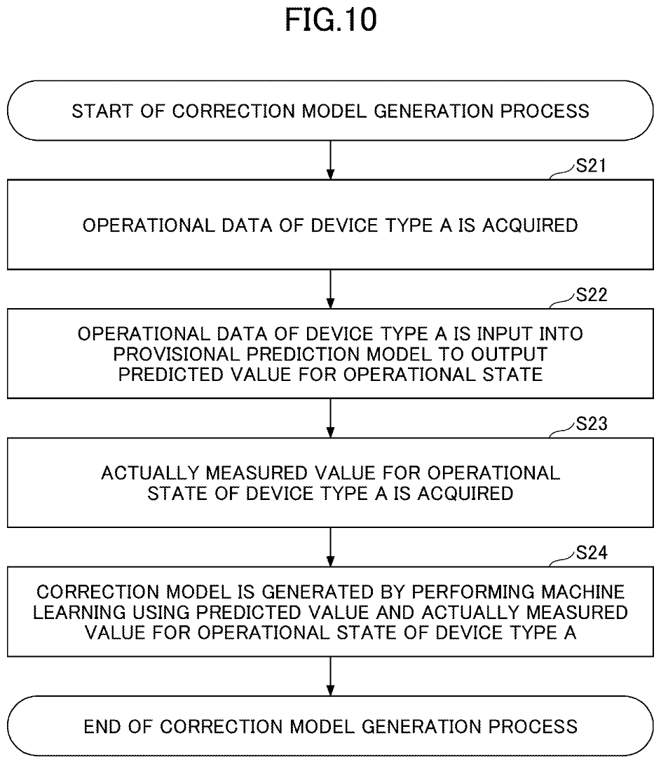

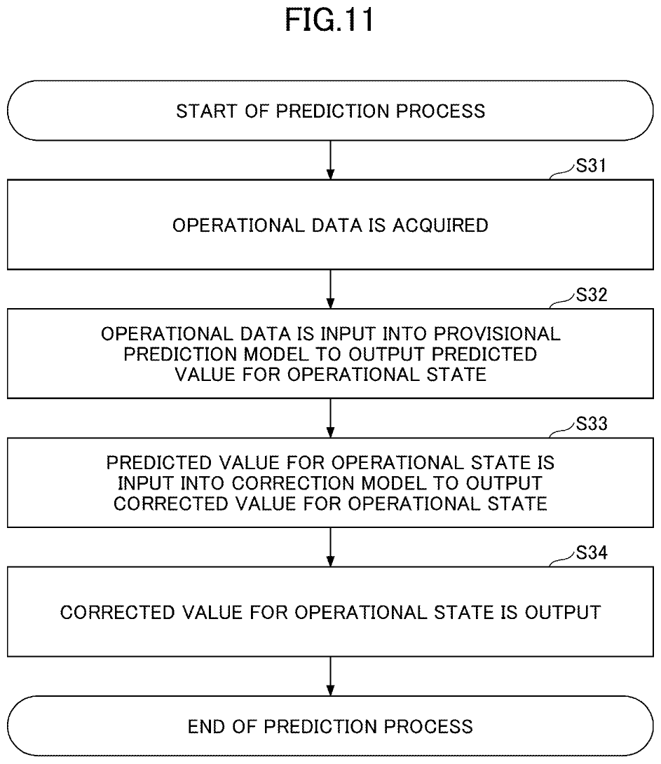

A provisional prediction model generation process will be described below with reference to FIG. 9. A correction model generation process will be described below with reference to FIG. 10. A prediction process will be described below with reference to FIG. 11.

FIG. 9 is a flowchart for the provisional prediction model generation process according to an embodiment of the present disclosure.

In the step 11 (S11), the provisional prediction model generation apparatus 600 acquires training data (operational data and an operational state of a device that is device type B). When the device type B is an old device type of the device type A, and a prediction model for the device type B has already been generated, this process may be omitted by using this prediction model as a provisional model.

In the step 12 (S12), the provisional prediction model generation apparatus 600 generates a provisional prediction model (i.e., a model for the device type B) 10 by performing machine learning by using the training data acquired in S11 (specifically, by performing machine learning by associating the operational data and the operational state of the device that is device type B with each other).

FIG. 10 is a flowchart for the correction model generation process according to an embodiment of the present disclosure.

In the step 21 (S21), the predicted value acquiring unit 402 acquires operational data of the device that is device type A.

In the step 22 (S22), the predicted value acquiring unit 402 inputs the operational data of the device that is device type A acquired in S21 into the provisional prediction model (i.e., the model for the device type B) 10, to output a predicted value for an operational state.

In the step 23 (S23), the actually measured value acquiring unit 403 acquires an actually measured value for the operational state of the device that is device type A (i.e., an operational state calculated from the operational data of the device that is device type A).

S23 may be performed first and S21 and S22 may be performed after S23, or S21 and S22 may be performed simultaneously with S23.

In the step 24 (S24), the training unit (correction model generation unit) 401 generates a correction model 20. Specifically, the training unit (correction model generation unit) 401 generates the correction model 20 by performing machine learning by associating the predicted value for the operational state of the device that is device type A acquired in S22 with the actually measured value for the operational state of the device that is device type A acquired in S23.

FIG. 11 is a flowchart for the prediction process according to an embodiment of the present disclosure.

In the step 31 (S31), the operational data acquiring unit 502 acquires operational data (specifically, operational data of the device that is device type A).

In the step 32 (S32), the prediction unit 501 acquires a predicted value for an operational state of the device that is device type A by inputting the operational data of the device that is device type A acquired in S31 into the provisional prediction model (i.e., the model for the device type B) 10 to output an operational state.

In the step 33 (S33), the prediction unit 501 acquires a corrected predicted value for the operational state of the device that is device type A by inputting the predicted value for the operational state of the device that is device type A acquired in S32 into the correction model 20 to output the corrected predicted value for the operational state.

In the step 34 (S34), the output unit 503 outputs the corrected predicted value for the operational state of the device that is device type A of S33. Subsequently, the corrected predicted value for the operational state of the device that is device type A may be used to sense leakage of a refrigerant from the device that is device type A, to sense a failure of the device that is device type A, or to control the device that is device type A.

<<Updating from “Provisional Prediction Model+Correction Model” to “Prediction Model”>>

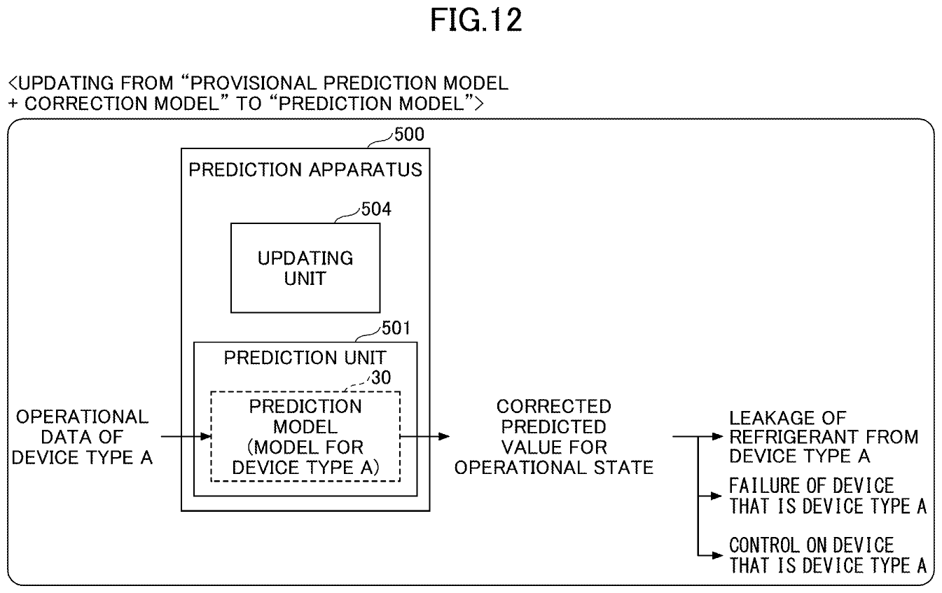

FIG. 12 is a diagram illustrating updating of the provisional prediction model and the correction model to a prediction model according to an embodiment of the present disclosure. The prediction apparatus 500 may include an updating unit 504 configured to update the provisional prediction model 10 and the correction model 20 to a prediction model for the device that is device type A. In this way, after operational data of the device that is device type A have been sufficiently accumulated, the prediction apparatus 500 can generate a prediction model for the device that is device type A as a replacement.

<<Updating of Correction Model>>

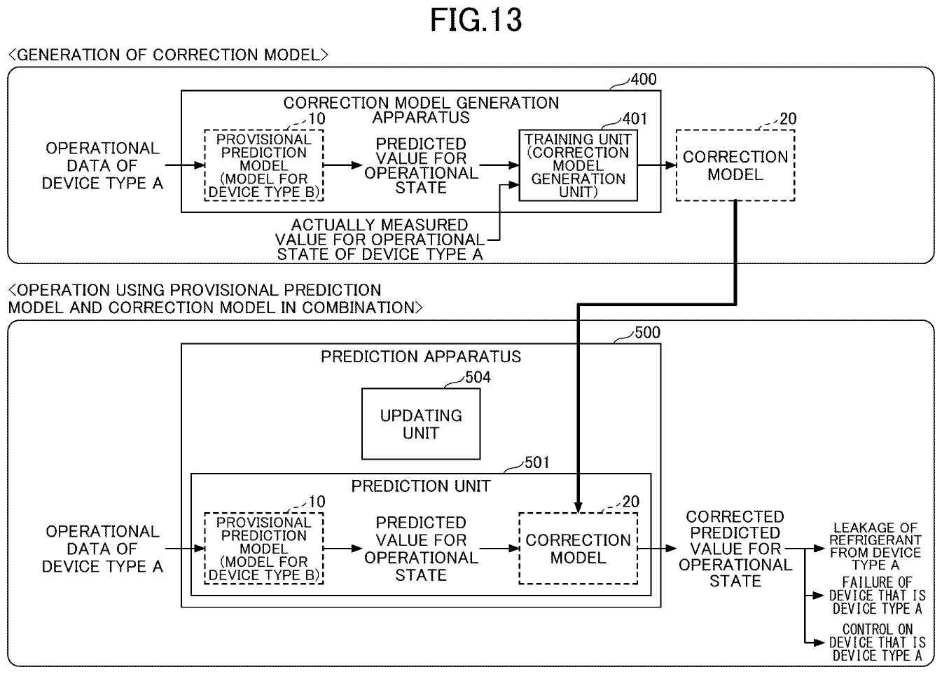

FIG. 13 is a diagram illustrating updating of the correction model according to an embodiment of the present disclosure. The prediction apparatus 500 may include an updating unit 504 configured to update the correction model. In this way, the prediction apparatus 500 can use the newest correction model.

<Correction Model Generation Example>

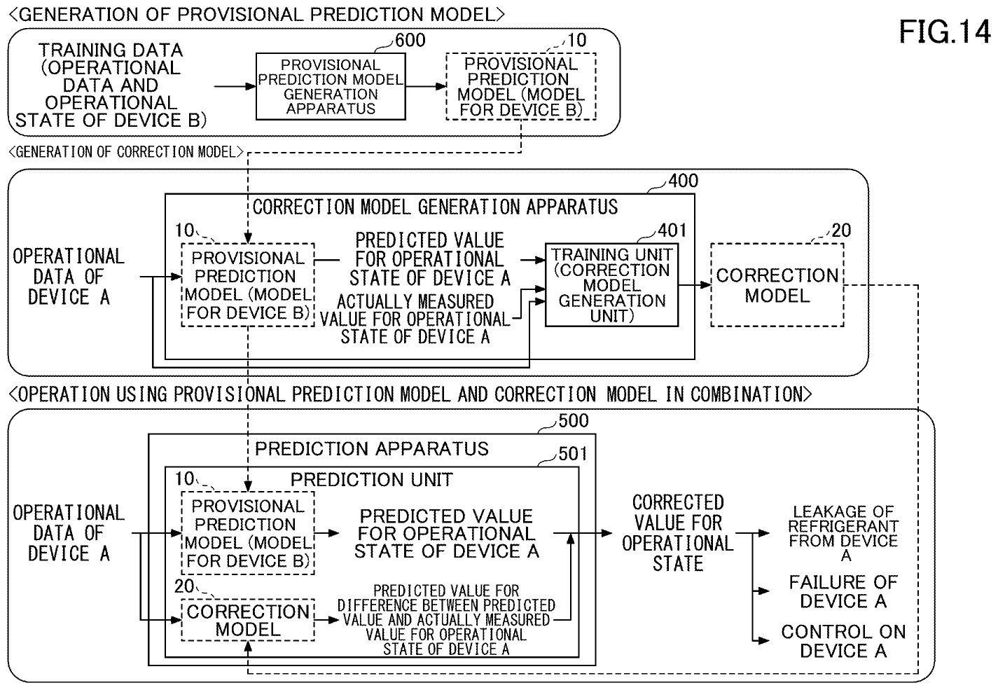

The prediction apparatus 500 can predict a difference between a predicted value for an operational state of the device and an actually measured value for the operational state of the device. The details will be described with reference to FIG. 14.

FIG. 14 is a diagram illustrating another embodiment for generation of a correction model according to an embodiment of the present disclosure. <Generation of provisional prediction model>, <Generation of correction model>, and <Operation using provisional prediction model and correction model in combination> will be described below in this order.

<Generation of Provisional Prediction Model>

First, the provisional prediction model generation apparatus 600 generates a provisional prediction model 10. Specifically, the provisional prediction model generation apparatus 600 generates a provisional prediction model (i.e., a model for a device B) 10 by performing machine learning by using training data (specifically, by performing machine learning by associating operational data and an operational state of the device B with each other).

<Generation of Correction Model>

Next, the correction model generation apparatus (an example of the correction apparatus) 400 generates a correction model 20. The correction model is a model configured to predict a difference between a predicted value for an operational state obtained by the provisional prediction model 10 and an actually measured value for the operational state.

Specifically, the correction model generation apparatus 400 acquires a predicted value for an operational state of the device A by inputting operational data of the device A into the provisional prediction model (i.e., the model for the device B) 10. The correction model generation apparatus 400 acquires an actually measured value for an operational state of the device A (specifically, an operational state calculated from the operational data of the device A). Moreover, the correction model generation apparatus 400 acquires operational data of the device A. Then, the correction model generation apparatus 400 generates a correction model 20 by performing machine learning by associating the predicted value for the operational state of the device A, the actually measured value for the operational state of the device A, and the operational data of the device A with one another.

<Operation Using Provisional Prediction Model and Correction Model in Combination>

Subsequently, the device A starts to be operated. The prediction apparatus 500 predicts an operational state from operational data of the device A.

Specifically, the prediction apparatus 500 acquires a predicted value for an operational state of the device A by inputting operational data of the device A into the provisional prediction model (i.e., the model for the device B) 10. Moreover, the prediction apparatus 500 acquires a predicted value for a difference between the predicted value and an actually measured value for the operational state of the device A by inputting the operational data of the device A into the correction model 20. Then, the prediction apparatus 500 acquires a corrected predicted value for the operational state based on the predicted value for the operational state of the device A, and the predicted value for the difference between the predicted value and the actually measured value for the operational state of the device A.

Embodiment 2 and Embodiment 3 will be described below. Description of any contents that are the same as those in Embodiment 1 will be omitted.

### Embodiment 2

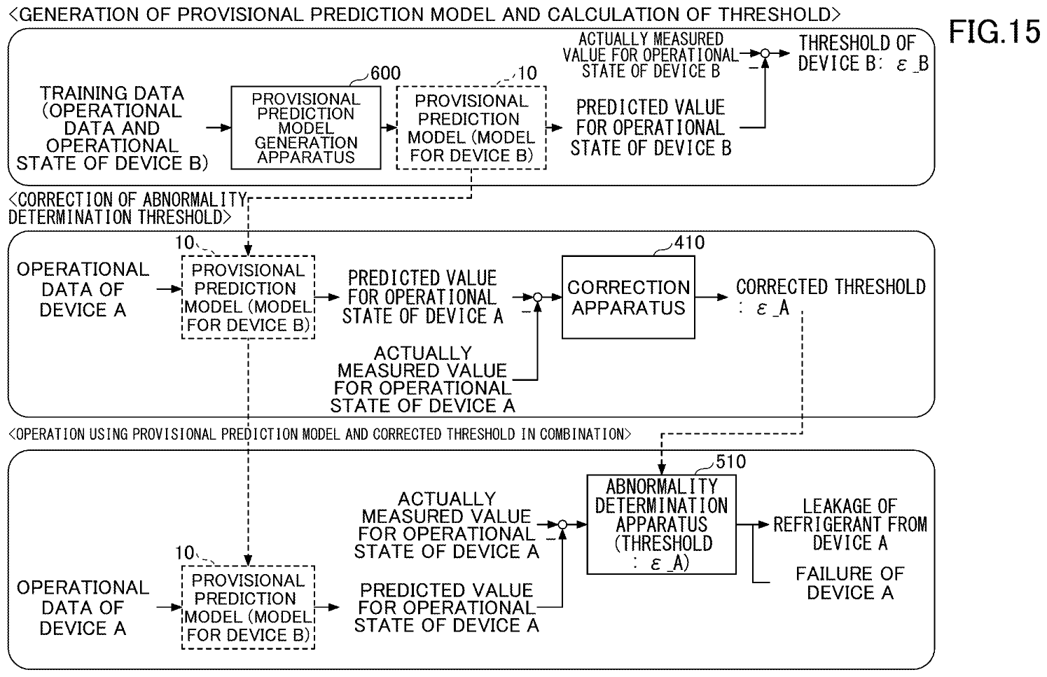

A correction apparatus 410 can correct a threshold for device abnormality determination by using a predicted value for an operational state of a device predicted using a provisional prediction model. The details will be described with reference to FIG. 15.

FIG. 15 is a diagram illustrating correction of an abnormality determination threshold according to an embodiment of the present disclosure. <Generation of provisional prediction model and calculation of threshold>, <Correction of abnormality determination threshold>, and <Operation using provisional prediction model and corrected threshold in combination> will be described below in this order.

<Generation of Provisional Prediction Model and Calculation of Threshold>

First, the provisional prediction model generation apparatus 600 generates a provisional prediction model 10. Specifically, the provisional prediction model generation apparatus 600 generates a provisional prediction model (i.e., a model for a device B) 10 by performing machine learning by using training data (specifically, by performing machine learning by associating operational data and an operational state of the device B with each other).

Moreover, a threshold for the device B (referred to as s B) is calculated from: a predicted value for an operational state of the device B (specifically, the operational state is output by inputting operational data of the device B into the provisional prediction model 10); and an actually measured value for the operational state of the device B (specifically, the actually measured value is an operational state calculated from the operational data of the device B). For example, where an average and a standard deviation of a Δ operational state quantity of the device B (=an actually measured value for an operational state quantity of the device B−a predicted value for the operational state quantity of the device B predicted by the provisional prediction model 10) are denoted by μ_b and σ_b, respectively, the threshold (ε_B) for the device B can be defined as “μ_b−3×σ_b”.

<Correction of Abnormality Determination Threshold>

Next, the correction apparatus 410 corrects the threshold. First, a predicted value for an operational state of the device A is acquired by inputting operational data of the device A into the provisional prediction model (i.e., the model for the device B) 10. Where an average and a standard deviation of a Δ operational state quantity of the device A (=an actually measured value for an operational state quantity of the device A−a predicted value for the operational state quantity of the device A predicted by the provisional prediction model 10) are denoted by μ_a and σ_a, respectively, a threshold (ε_A) for the device A can be defined as “μ_a−3×σ_a”. In this way, the threshold is corrected from ε_B to ε_A.

<Operation Using Provisional Prediction Model and Corrected Threshold in Combination>

Subsequently, the device A starts to be operated. An abnormality determination apparatus 510 determines abnormality from operational data of the device A. Specifically, the abnormality determination apparatus 510 determines an abnormality (e.g., leakage of a refrigerant from the device A or a failure of the device A) by comparing the Δ operational state quantity of the device A (=an actually measured value for an operational state quantity of the device A−a predicted value for the operational state quantity of the device A predicted by the provisional prediction model 10) with the threshold (ε_A) for the device A.

### Embodiment 3

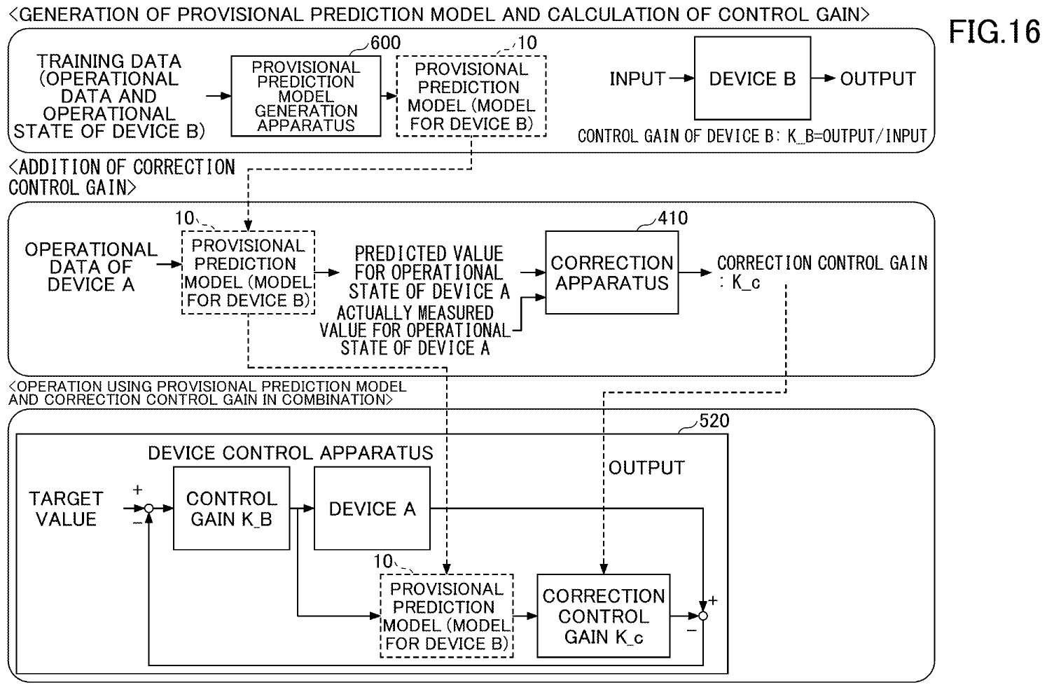

The correction apparatus can correct a control gain involved in controlling a device by using a predicted value for an operational state of the device predicted using a provisional prediction model. The details will be described with reference to FIG. 16.

FIG. 16 is a diagram illustrating correction of a control gain involved in device control according to an embodiment of the present disclosure. <Generation of provisional prediction model and calculation of control gain>, <Addition of correction control gain>, and <Operation using provisional prediction model and correction control gain in combination> will be described below in this order.

<Generation of Provisional Prediction Model and Calculation of Control Gain>

First, the provisional prediction model generation apparatus 600 generates a provisional prediction model 10. Specifically, the provisional prediction model generation apparatus 600 generates a provisional prediction model (i.e., a model for a device B) 10 by performing machine learning by using training data (specifically, by performing machine learning by associating operational data and an operational state of the device B with each other).

Moreover, a control gain of the device B (an output from the device B (an actually measured value for an operational state)/an input into the device B (an actually measured value for operational data)) is calculated. The control gain of the device B is referred to as “K_B”.

<Addition of Correction Control Gain>

Next, the correction apparatus 410 calculates a correction control gain to be added. A correction control gain (a correction coefficient for an output from the provisional prediction model (i.e., the model for the device B) 10) is referred to as “K_c”. The correction control gain (K_c) is “an output (an actually measured value for an operational state) from the device A/an output (a predicted value for the operational state) from the provisional prediction model (i.e., the model for the device B) 10” with respect to the same input. Hence, a predicted value for the output from the device A can be calculated according to K_c×the output from the provisional prediction model (i.e., the model for the device B) 10.

<Operation Using Provisional Prediction Model and Correction Control Gain in Combination (Example of Application to Internal Model Control (IMC)>

Subsequently, the device A starts to be operated. A device control apparatus 520 controls the device A by using the provisional prediction model (i.e., the model for the device B) 10 and the correction control gain (K_c), which is the correction coefficient for an output from the provisional prediction model (i.e., the model for the device B) 10. Specifically, the device control apparatus 520 performs control such that an output from the device A (an actually measured value for an operational state) becomes closer to a target value. In the present embodiment, a gain for correcting an output from the provisional prediction model (i.e., the model for the device B) 10 is added. However, a gain for correcting the control gain K_B of the device B may be added.

Embodiments have been described above. It will be understood that various modifications are applicable to the embodiments and particulars without departing from the spirit and scope of the claims.

### EXPLANATION OF REFERENCES

1: CPU
2: ROM
3: RAM
4: auxiliary memory device
5: display device
6: operation device
7: I/F device
8: bus
10: provisional prediction model
20: correction model
100: air conditioning system
200: outdoor unit
201: outdoor heat exchanger
201-1: outdoor heat exchanger (condenser)
201-2: outdoor heat exchanger (evaporator)
202: compressor
203: supercooling heat exchanger
204: supercooling heat exchanger expansion valve
205: outdoor unit main expansion valve
206: four-way valve
300: indoor unit
300-1: air-warming indoor unit
300-2: air-cooling indoor unit
301: indoor heat exchanger
302: indoor heat exchanger expansion valve
400: correction model generation apparatus
401: training unit (correction model generation unit)
402: predicted value acquiring unit
403: actually measured value acquiring unit
410: correction apparatus
500: prediction apparatus
501: prediction unit
502: operational data acquiring unit
503: output unit
504: updating unit
510: abnormality determination apparatus
520: device control apparatus
600: provisional prediction model generation apparatus

What is claimed is:

1. An apparatus configured to perform correction regarding a predicted value for an operational state predicted from operational data of a first device, the apparatus comprising:
a processor;
a provisional prediction model that is trained by machine learning based on training data including operational data and an operational state of a second device different from the first device;
a memory storing one or more programs, which when executed, cause the processor to:
perform correction regarding the predicted value for the operational state of the first device, the predicted value being predicted using the provisional prediction model.

2. The apparatus according to claim 1,
wherein the one or more programs, when executed, cause the processor to:
generate a correction model configured to correct the predicted value for the operational state of the first device, the predicted value being predicted using the provisional prediction model.

3. The apparatus according to claim 2,
wherein the one or more programs, when executed, cause the processor to:
acquire the predicted value for the operational state of the first device by inputting the operational data of the first device into the provisional prediction model to output the operational state of the first device;
acquire an actually measured value for the operational state of the first device; and
perform machine learning by associating the predicted value for the operational state of the first device with the actually measured value for the operational state of the first device.

4. An apparatus, comprising:
a processor;
a provisional prediction model that is trained by machine learning based on training data including operational data and an operational state of a second device;
a correction model configured to correct a predicted value for an operational state of a first device different from the second device, the predicted value being predicted using the provisional prediction model; and
a memory storing one or more programs, which when executed, cause the processor to:
acquire operational data of the first device; and
predict the predicted value for the operational state of the first device from the operational data of the first device using the provisional prediction model, and predict a corrected predicted value for the operational state of the first device from the predicted value for the operational state of the first device using the correction model.

5. The apparatus according to claim 4,
wherein the one or more programs, when executed, cause the processor to:
acquire the predicted value for the operational state of the first device by inputting the operational data of the first device into the provisional prediction model to output the operational state of the first device; and
acquire the corrected predicted value for the operational state of the first device by inputting the predicted value for the operational state of the first device into the correction model to output the corrected predicted value for the operational state of the first device.

6. The apparatus according to claim 5,
wherein the one or more programs, when executed, cause the processor to:
further input the operational data of the first device into the correction model together with the predicted value for the operational state of the first device.

7. The apparatus according to claim 4,
wherein a device used for generating the correction model is a device that is same as and of a same device type as that of the first device for which the processor performs prediction.

8. The apparatus according to claim 4,
wherein a device used for generating the correction model is one or a plurality of devices different from and of a same device type as that of the first device for which the processor performs prediction.

9. The apparatus according to claim 4,
wherein a device used for generating the correction model includes a device that is same as and of a same device type as that of, and one or a plurality of devices different from and of a same device type as that of, the first device for which the processor performs prediction.

10. The apparatus according to claim 4,
wherein the one or more programs, when executed, cause the processor to:
update the provisional prediction model and the correction model to a prediction model for the first device.

11. The apparatus according to claim 4,
wherein the one or more programs, when executed, cause the processor to:
update the correction model.

12. The apparatus according to claim 1,
wherein a device type of the first device is a new device type of the second device.

13. The apparatus according to claim 1,
wherein the first device has a function similar to that of the second device.

14. The apparatus according to claim 1,
wherein the first device and the second device are air conditioners.

15. The apparatus according to claim 1,
wherein the operational state is used for at least any one selected from leakage of a refrigerant from the first device, a failure of the first device, and control on the first device.

16. The apparatus according to claim 4,
wherein the one or more programs, when executed, cause the processor to:
predict a difference between the predicted value for the operational state of the first device and an actually measured value for the operational state of the first device.

17. The apparatus according to claim 1,
wherein the one or more programs, when executed, cause the processor to:
correct an abnormality determination threshold by using the predicted value for the operational state of the first device, the predicted value being predicted using the provisional prediction model.

18. The apparatus according to claim 1,
wherein the one or more programs, when executed, cause the processor to:
correct a control gain, the control gain being involved in a control using the predicted value for the operational state of the first device, the predicted value being predicted using the provisional prediction model.

19. A method of performing correction regarding a predicted value for an operational state predicted from operational data of a device, the method comprising:
performing correction regarding a predicted value for the operational state of the device, the predicted value being predicted using a provisional prediction model that is trained by machine learning based on training data including operational data and an operational state of a device different from the device.

20. A non-transitory computer-readable recording medium storing a program causing a computer, which is configured to perform correction regarding a predicted value for an operational state predicted from operational data of a device, to:
perform correction regarding a predicted value for the operational state of the device, the predicted value being predicted using a provisional prediction model that is trained by machine learning based on training data including operational data and an operational state of a device different from the device.

21. A method, comprising:
acquiring operational data of a device; and
predicting a corrected predicted value, which is a predicted value for an operational state of the device that is corrected, from the operational data of the device, using: a provisional prediction model that is trained by machine learning based on training data including operational data and an operational state of a device different from the device; and a correction model configured to correct the predicted value for the operational state of the device, the predicted value being predicted using the provisional prediction model.

22. A non-transitory computer-readable recording medium storing a program causing a computer to:
acquire operational data of a device; and
predict a corrected predicted value, which is a predicted value for an operational state of the device that is corrected, from the operational data of the device, using: a provisional prediction model that is trained by machine learning based on training data including operational data and an operational state of a device different from the device; and a correction model configured to correct the predicted value for the operational state of the device, the predicted value being predicted using the provisional prediction model.

23. A correction model configured to correct a predicted value for an operational state predicted from operational data of a device, the correction model causing a computer to function to:
correct a predicted value for the operational state of the device, the predicted value being predicted using a provisional prediction model that is trained by machine learning based on training data including operational data and an operational state of a device different from the device.
